(19) United States
(12) Patent Application Publication
(10) Pub. No.: US 2018/0246938 A1
(43) Pub. Date: Aug. 30, 2018

(54) PERSONALIZED PROFILE-MODIFIED SEARCH FOR DIALOG CONCEPTS

(71) Applicant: ENT. SERVICES DEVELOPMENT CORPORATION LP, Houston, TX (US)

(72) Inventors: Kas KASRAVI, West Bloomfield, MI (US); Kieran MCCORRY, Belfast (GB); Simon THOMASON, Ashford, NJ (US); Marie RISOV, Bloomfield Hills, MI (US); Mark DONNELLY, Galway (IE)

(73) Assignee: ENT. SERVICES DEVELOPMENT CORPORATION LP, Houston, TX (US)

(21) Appl. No.: 15/552,463

(22) PCT Filed: Feb. 20, 2015
(86) PCT No.: PCT/US2015/016811

§ 371 Date: Aug. 21, 2017

(51) Int. Cl. G06F 17/30

(52) U.S. Cl. CPC G06F 17/30522; G06F 17/30401

(57) ABSTRACT

In example implementations, dialog keywords are extracted from a dialog of participants as a search query. The dialog keywords represent primary concepts of the dialog. The search query is modified based on a personalized profile of a participant generated from at least a contextual information source regarding the participant other than prior search queries made by the participant. The modified search query is evaluated against an information store to retrieve search results relevant to the modified search query, and the search results output to the participant.

### BACKGROUND

In enterprise and other environments, people commonly find themselves communicating with one another even when they are located at different places throughout the same building, throughout the same country, or even throughout the world. Technology affords the ability for two or more people to communicate with one another using a variety of different modalities. Examples of such modalities include sound communication, both sound and video communication, text communication, and various combinations thereof, such as sound and text communication, as well as sound, video, and text communication.

### BRIEF DESCRIPTION OF THE DRAWINGS

FIG. 1 is a flowchart of an example method for generating personalized search results for a selected participant of a dialog that relate to concepts or topics of the dialog.

FIG. 2 is a flowchart of an example method for generating collective search results for participants of a dialog that relate to concepts or topics of the dialog.

FIGS. 3 and 4 are flowcharts of example methods for selecting which keywords of a participant's personalized profile on which basis to modify a base search query by leveraging different personas of the participant in his or her personalized profile.

FIGS. 5 and 6 are diagrams of example systems in which personalized and collective search results generation for participants of a dialog can be achieved.

FIG. 7 is a flowchart of another example method for generating personalized search results for a selected participant of a dialog that relate to concepts or topics of the dialog.

FIG. 8 is a flowchart of another example method for generating collectively search results for participants of a dialog that relate to concepts or topics of the dialog.

FIG. 9 is a diagram of another example system in which personalized and collective search results generation for participants of a dialog can be achieved.

### DETAILED DESCRIPTION

As noted in the background, two or more users can communicate with one another even if they are located in different places. For example, users working on the same team may periodically or on an ongoing basis have a text-based chat session or conference in which they discuss problems they are encountering, proposed solutions, and status updates with respect to a common goal. Such a discrete or ongoing communication session, using the same communication modality or different communication modalities, is referred to as a dialog herein. Communication sessions can occur in real-time among the participants, as is the case with text-based chat sessions, teleconferences, and videoconferences, or in non-real time, as is the case with email-based communication sessions, for instance.

For example, a dialog may be a text-based chat session that was held at a particular time and that lasts a particular length of time, which is a discrete communication session. A dialog may be a text-based chat session that by comparison is ongoing, in which throughout the day or over a longer period of time users periodically communicate with one another regarding a particular project, for instance. Some users in a dialog may participate in one modality, such as by sound only, whereas other users may participate in a different modality, such as by both sound and video. A dialog can indeed switch modalities over time; for example, a dialog may begin as a text-based chat session, and then segue to a sound and video-based session as desired.

Techniques disclosed herein leverage such dialogs to provide dialog participants with further information regarding the topics that have been discussed in a dialog. Two general techniques can be separately employed or used in combination. In the first technique, for each participant, dialog keywords are extracted from the dialog. The dialog keywords represent primary concepts of the dialog, and represent a base search query. The base search query may be the dialog keywords of just the contributions of the participant in question, or all the participants' contributions in the dialog (or the contributions of at least one participant other than the participant in question).

The base search query is then modified based on a personalized profile of each participant. The personalized profile of a participant is generated from at least a contextual information source regarding the participant other than prior search queries, such as social media web sites, online corporate directories, and so on. Each modified search query is evaluated against an information store, such as by using an Internet search engine, to retrieve search results relevant to the modified search query. Each participant in this technique thus receives individualized search results that have effectively been tailored to him or her because the search query is modified based on just that participant's personalized profile.

In the second technique, dialog keywords are again extracted from the dialog, and are typically the dialog keywords of all the participants' contributions (or the contributions of more than one participant) in the dialog. The base search query can be modified based on the personalized profiles of the participants. The modified search query is again evaluated against an information store to retrieve results relevant to the modified search query. Each participant in this technique thus receives collective search results that reflect the personalized profiles of more than one participant in the dialog, such as all the participants in the dialog.

As an example, in a dialog regarding a new product, an engineer and a lawyer may be communicating with one another regarding the challenges associated with the product. The lawyer may be more interested in and provide information regarding the regulations that the product has to satisfy, and the engineer may be more interested in and provide information regarding changes in the product's design to satisfy these regulations. Both participants may have accounts with a professional-oriented social media site identifying their professions, education, current and prior places of employment, professional interests, and so on, from which a different personalized profile is constructed for each participant. Thus, the individualized search results that each participant can receive differ based on their different personalized profiles, and both participants can receive the same collective search result results based on the personalized profiles of both of them.

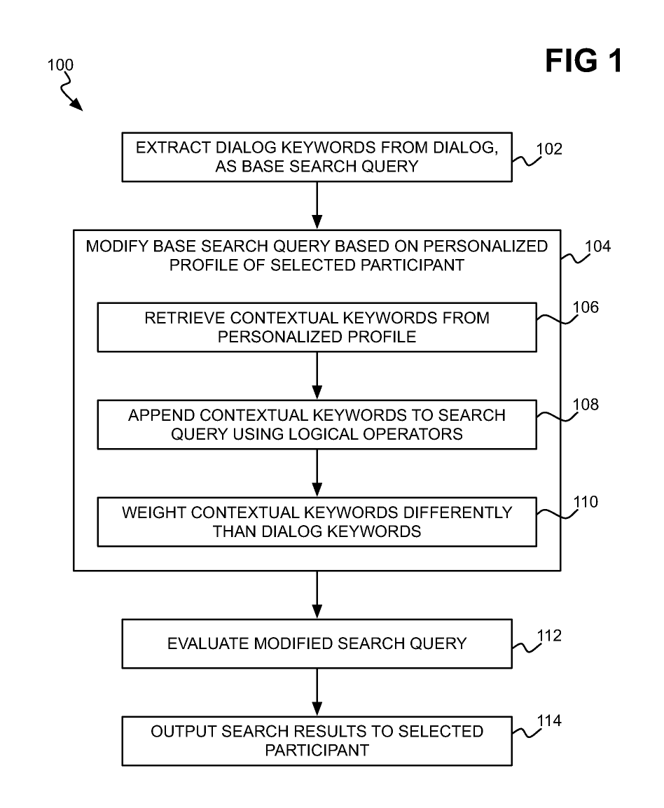

FIG. 1 shows an example method 100 for generating personalized search results for a participant of a dialog. The method 100 is described in relation to a selected participant, but can be performed for each participant of the dialog that wishes to receive such personalized search results. The method 100 is performed by a processor of a computing device. The method 100 may therefore be implemented as computer-executable code of a computer program that the processor executes to perform the method 100.

The method 100 includes extracting, from the dialog, dialog keywords, which collectively are referred to as a base search query (102). The dialog keywords represent the primary concepts, or topics, of the dialog. In general, dialog keyword extraction is performing using natural language processing (NLP) techniques. NLP techniques permit computing devices to derive meaning from the human-entered natural language input of the contextual information of the contextual information sources. NLP techniques can employ machine learning, such as statistical machine learning, techniques. Other examples of available NLP techniques include co-reference resolution, morphological segmentation, named entity recognition, part-of-speech tagging, parsing, semantic analysis, and word sense disambiguation.

The text of a dialog is thus analyzed to determine or extract the dialog keywords therefrom. If the dialog is a text-only communication session, then the session directly supports such analysis. However, the dialog may include speech, in which case the speech is first converted to text before dialog extraction occurs. Furthermore, in some types of communication sessions, images, documents, and other data may be shared among the participants. In this case, the dialog keyword extraction can be based on the text of such data, which may first include performing optical character recognition (OCR) or other techniques on image and types of data other than text.

In the method 100, the dialog keywords may be extracted from just the selected participant's contributions to the dialog, or from all the participants' contributions (or the contributions of at least one participant other than just the selected participant). For example, a text-only communication session is a dialog in which each participant inputs text that is sent to the other participants for display. The text input by a participant is the contribution to the dialog by that participant. Thus, in part 102, the method 100 can extract the dialog keywords that form the base search query from just the selected participant's contribution to the dialog, or from the dialog as a whole such that extraction is performed in relation to all the participants' contributions (or the contributions of at least one participant other than the selected participant).

The method 100 includes modifying the base search query based on the personalized profile of the selected participant (104). The personalized profile is a set of contextual keywords that is statically or dynamically (i.e., periodically) updated, and is used to modify search queries so that the search results are more relevant to the participant. The personalized profile is preexisting, having been previously generated from contextual information available from one or more contextual information sources. An example of how the personalized profile of a participant can be so generated is described in the patent application entitled “Search query modification using personalized profile,” which was filed on the same day as the present patent application.

Contextual information of the participant is information regarding the participant that provides background information of the participant, so that search queries later made by the participant can be more fully assessed. Contextual information of the participant provides meaning to search queries, insofar as it provides information regarding the participant that made the queries. The contextual information sources can include prior search queries that the participant made, as well as other types of contextual information sources. Examples include social media web sites, including professionally oriented such web sites. A participant typically lists personal and professional information on such web sites, such as the participant's interests, hobbies, work history, education, and so on. The present dialog as well as past dialogs can further serve as contextual information sources.

The contextual keywords of the selected participant's personalized profile can be of differing types. Domain keywords can include the domains of the type of information in which the participant is likely interested. For example, an employment lawyer may have contextual information that results in domain keywords such as “employment law,” whereas a chemist may have contextual information that results in the extraction of domain keywords such as “chemistry.” Other types of contextual keywords include language keywords specifying the languages understood by the participant, such as English, Japanese, French, and so on, as well as reading level keywords specifying the reading level of the participant, such as high school reading level, college reading level, and so on. Still other types of contextual keywords include location keywords specifying the locations where the participant has been, went to school, currently lives and lived in the past, and so on.

Modifying the base search query based on the personalized profile of the selected participant can include the following. Contextual keywords are retrieved from the participant's personalized profile (106). The contextual keywords are then appended to the base search query using logical operators (108).

As an example, consider the base search query “unionized” for two different participants, an employment lawyer and a chemist. The contextual keyword of the lawyer's personalized profile may be “law,” whereas the contextual keyword of the chemist's personalized profile may be “chemistry.” The contextual keyword is added or appended to the base search query using a logical AND operator, so that the modified search query is “unionized AND law” for the lawyer and is “unionized AND chemistry” for the chemist. The search query is thus refined so that it is likely to result in more relevant search results for a particular participant.

For multiple contextual keywords, the base search query can be modified by appending the contextual keywords to the query using a logical AND operator and separating each keyword within the modified query using a logical OR operator. Thus, for the base search query QUERY and the contextual keywords KEYWORD1 and KEYWORD2, the resulting modified search query is “QUERY AND (KEYWORD1 OR KEYWORD2).” In this modified search query, the terms “AND” and “OR” are the logical operators AND and OR, respectively.

The contextual keywords may have weights associated with the importance of the keywords within the personalized profile of the selected participant. Where evaluation of search queries using weights is supported, such as by an Internet search engine that supports weighted query terms, each keyword may further be multiplied or modified by its associated weight. For example, a contextual keyword KEYWORD1 may have a weight of 90% on a scale from 0-100%, whereas a contextual keyword KEYWORD2 may have a weight of 30%. For the base search query QUERY and these keywords, the resulting modified search query may “QUERY AND (90%×KEYWORD1 OR 30%×KEYWORD2),” or “QUERY AND (KEYWORD WITH 90% WEIGHT OR KEYWORD2 WITH 30% WEIGHT),” depending on how weights are specified for evaluation.

Furthermore, the method 100 can weight the dialog keywords of the modified search keyword differently than the contextual keywords of the modified search query (110), where evaluation of search queries using weights is supported. This type of weighting is in addition to the weights that the contextual keywords may already have within the personalized profile of the selected participant. The dialog keywords may be weighted by a first coefficient, for instance, whereas the contextual keywords may be weighted by a second coefficient. Such weighting permits biasing the search that is performed towards the contextual keywords or towards the dialog keywords as desired. A selected participant may be able to specify the coefficients, or they may be specified for the participant. Furthermore, the coefficients may be dynamically adjusted over time, manually or programmatically, so that more desirable search results are retrieved.

For example, the dialog keywords of the modified search query may be DIALOG1 and DIALOG2, whereas the contextual keywords of the modified search query may be CONTEXTUAL1 and CONTEXTUAL2. The weighting coefficients of the dialog keywords and of the contextual keywords may be DWT and CWT, respectively. The resulting modified search query is thus “[DWT×(DIALOG1 OR DIALOG2)] AND [CWT×(CONTEXTUAL1 OR CONTEXTUAL 2)].”

The method 100 evaluates the resulting modified search query against an information store to retrieve search results relevant to the modified search query (112). Stated another way, the method 100 evaluates the resulting modified search query against the information store to retrieve search results relevant to the search query for the selected participant. The information store is a database storing information items that are searched, where items matching the modified search query are the search results. In the context of an Internet search engine, the information items may be web page summaries and web page links. In this example, the method 100 may send the modified search query to the Internet search engine and responsively receive the search results, or the method 100 can be implemented as part of the search engine itself. The search results are then output to the selected participant for review (114), such as by being displayed to the selected participant on the same or different computing device as that which is performing the method 100.

As has been described, the contextual keywords of the selected participant's personalized profile are retrieved and appended to the base search query to generate a modified search query that will likely provide search results that are more relevant to the participant. In the simplest form, all the contextual keywords may be retrieved from the selected participant's personalized profile and appended to the search query. However, a personalized profile may include a large number of contextual keywords, such as hundreds or more, and in some implementations it may be appropriate to select the best contextual keywords for adding or appending to the search query.

Relevant contextual keywords may be selected in a number of different ways. For example, an external information source may be employed to better categorize the search query. Examples of such information sources include online encyclopedias, industry-specific glossaries, reference materials for particular subject matter, and so on. A search query of “unionized,” for instance, may be categorized as being related to a scientific and/or professional field such as physics and law. Therefore, if either of these two contextual keywords is present in the participant's personalized profile, it is selected as a contextual keyword to add or append to the search query.

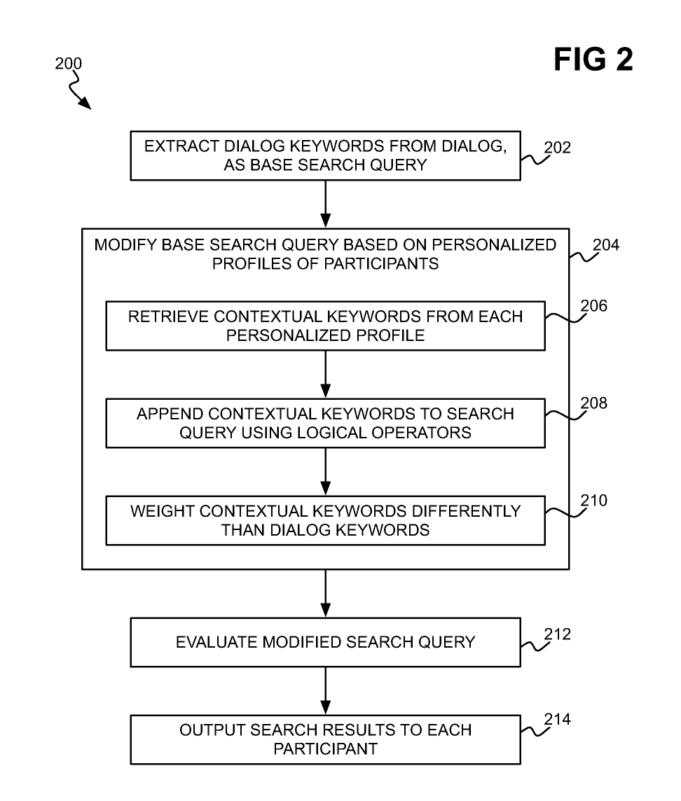

FIG. 2 shows an example method 200 for generating collective search results for participants of a dialog, such as all the participants of the dialog. As with the method 100, the method 200 is performed by a processor of a computing device. The method 200 may thus be implemented as computer-executable code that the processor executes to perform the method 200.

The method 200 includes extracting, from the dialog, dialog keywords, which collectively are referred to as a base search query (202). The extraction of part 202 is performed in generally the same way as the extraction of part 102 of the method 100 that has been described. The difference is that because the method 200 generates collective search results, as opposed to individualized search results, the dialog keywords are determined in part 202 from the contributions of more than one participant of the dialog, such as all the participants, and not just from the contribution of a selected participant, as can be the case in part 102. That is, the method 200 can extract dialog keywords from the dialog as a whole.

The method 200 includes modifying the base search query based on the personalized profiles of the participants of the dialog (204). Unlike the search query modification of part 104 of the method 100, the modification of part 204 is thus performed based on the personalized profiles of more than one participant of the dialog, such as all the participants. The personalized profiles of the participants on which basis the base search query is modified in part 204 can be the profiles of the participants whose contributions were used to extract the dialog keywords in part 202.

Modifying the base search query based on the personalized profiles of the participants of the dialog can include the following. Contextual keywords are retrieved from each participant's profile (206). The contextual keywords are appended to the base search query using logical operators (208), and the contextual keywords can be weighted differently than the dialog keywords (210).

In this respect, parts 206, 208, and 210 of the method 100 are performed in generally the same way as the corresponding parts 106, 108, and 110 of the method 100 that have been described. The difference is that rather than retrieving and appending the contextual keywords of the personalized profile of just a selected participant as in the method 100, the method 200 retrieves and appends the contextual keywords of at least more than one participant of the dialog, such as all the participants of the dialog. This ensures that the modified search query will yield search results that are collective in nature in the method 200, as opposed to being personalized in nature as in the method 100.

The method 200 evaluates the resulting modified search query against an information store to retrieve search results relevant to the modified search query (212), as in part 112 of the method 100. For example, the method 200 may send the modified search query to an Internet search engine and responsively receive the search results to perform the search using the modified search query to retrieve search results that are relevant. The search results are then output (i.e., displayed or provided) to each participant of the dialog that is interested in receiving them (214).

In an implementation in which both the methods 100 and 200 are performed for each participant of a dialog, each participant thus receives two types of search results: individualized search results and collective search results. The individualized search results that the participants receive can and typically do differ for each participant, since the participants' personalized profiles are in all likelihood different from one another. By comparison, the collective search results that each participant receives are identical to the collective search results that any other participant receives.

Via the methods 100 and 200, a participant of a dialog obtains further information related to the topics and concepts discussed in the dialog. The information is provided on two levels. The first level is a personalized level, and includes the individualized search results tailored to the participant in question based on his or her personalized profile. The second level is a collective level, and includes the collective search results that are applicable to the personalized profiles of the participants of the dialog as a group. The techniques disclosed herein thus advantageously provide relevant additional information to the participants of the dialog in at least one of two different ways.

In either or both the methods 100 and 200, the base search query may further be modified to take into account the current context of a participant. The current context of the participant includes the circumstances surrounding a participant's present situation. For instance, the current context can include or be based on the current time and/or day, the participant's current location, the computing device that the participant is currently using to perform a search, and so on. In one implementation, additional context search terms may be added or appended as context keywords to the search query similar to as in parts 108 and 208, and may be weighted similar to as in parts 110 and 210.

In another implementation, however, the current context of a participant can be reflected in the contextual keywords of the modified search query based on personas of the participant within the participant's personalized profile. A persona of a participant is a grouping of the contextual keywords of the participant's personalized profile. The personas of a participant can correspond to the participant's different life roles, and can correspond to different types of contextual information regarding the participant. As one example, the participant may have a professional persona and a personal persona. Contextual keywords related to the participant's job, for instance, may be organized as part of his or her professional persona, whereas contextual keywords related to the participant's interests and hobbies may be organized as part of his or her personal persona. The personas as a whole make up the participant's personalized profile.

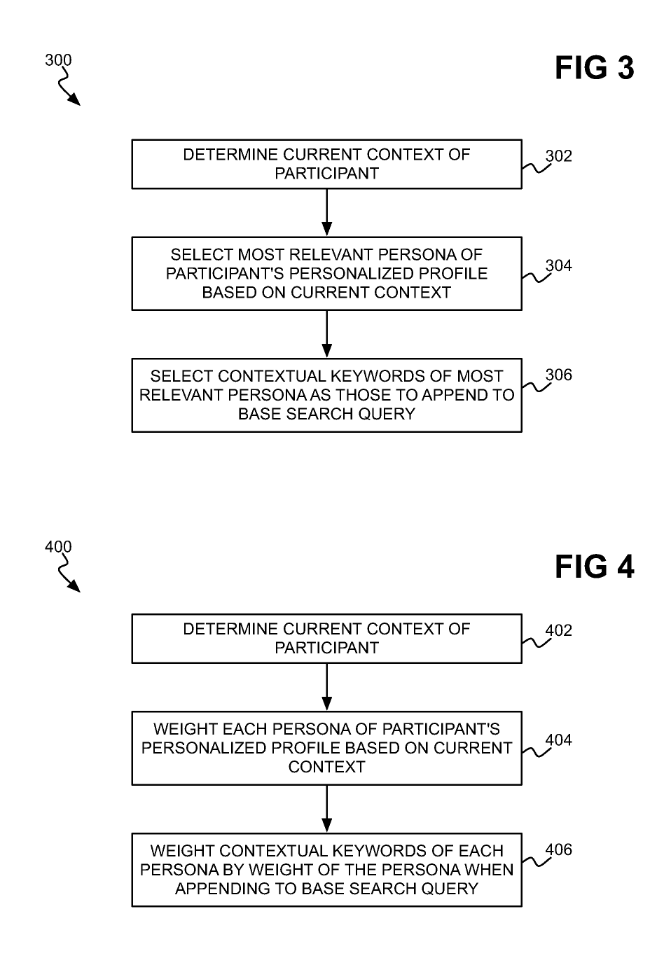

FIGS. 3 and 4 show example methods 300 and 400, respectively for selecting relevant contextual keywords of a participant's personalized profile when the keywords are organized over personas. The methods 300 and 400 are thus other ways by which selected contextual keywords of a personalized profile are selected to add or append to a search query. The methods 300 and 400 may each be performed between parts 106 and 108 of the method 100 and/or between parts 206 and 208 of the method 200, for instance. In the method 100, the methods 300 and 400 are performed in relation to the selected participant, whereas in the method 200, the methods 300 and 400 are performed in relation to each of at least one participant, such as all the participants, of the dialog.

In the method 300, a participant's current context is determined (302). The most relevant of the participant's personas within the personalized profile of the participant is selected based on the participant's current context (304). This is achieved by matching the current context to the personas to identify the current persona. For example, the participant may have a work persona and a personal persona. If the current context is 2 PM on a workday, the participant's current location is his or her workplace, and the participant is currently using his or her work computer, then the work persona is most likely the participant's current persona. By comparison, if the current context is 8 PM on a Friday, the participant's current location is his or her home, and the participant is currently using his or her home computer, then the personal persona is most likely the participant's current persona.

The method 300 selects the contextual keywords within the participant's personalized profile that are organized under the most relevant (i.e., current) persona as those to add or append to the search query that has been entered by the participant (306). The contextual keywords organized under other personas, by comparison, are not added or appended. It can thus be stated that the base search query is modified based on just the current persona of the participant, which is the most relevant persona for the participant's current context.

In the method 400, the participant's current context is again determined (402), as in part 302 of the method 300. However, rather than selecting the most relevant persona of the participant as in the method 300, the method 400 weights each persona of the participant's personalized profile based on the current context (404). For example, the participant may have a work persona and a personal persona, as before. If the current context is 7 PM, the participant's current location is his or her home, and the participant is currently using his or her work computer, it may be unclear as to whether the participant is in a work persona or a personal persona.

The fact that it is 7 PM—outside of normal business hours—suggests a personal persona, as does the fact that the participant's current location is at home. However, the fact that the participant is using his or her work computer suggests that the participant may be working from home in the evening, and thus suggests a work persona. If each of these criteria (current time, current location, and current computing device) is weighted equally, then the work persona has a weight of one (or one third) since it satisfies one criterion. By comparison, the personal persona has a weight of two (or two thirds) since it satisfies the other two criteria.

The contextual keywords of each persona are thus weighted by the persona's weight when adding or appending the keywords to the base search query (406). It is noted that such weighting is different than and can be in addition to the weights that have been described above in relation to the method 300 and to part 408 of the method 400, which are weights on a contextual keyword basis, not on a persona basis as in the method 400. The method 400 is a way in which the search base query is modified based on the participant's personas, as weighted by the participant's current context.

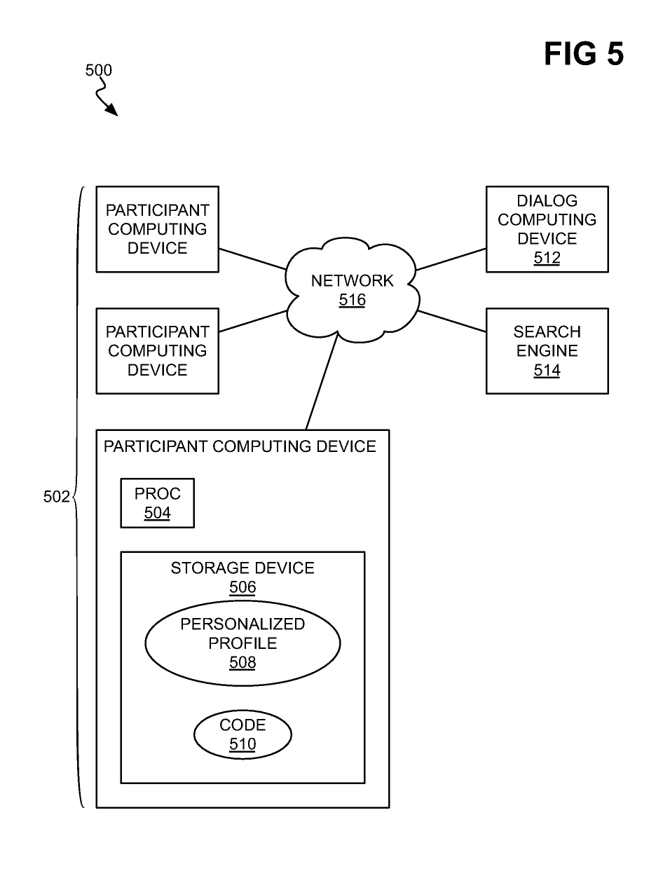

FIGS. 5 and 6 show example systems 500 and 600, respectively, of how the techniques disclosed herein for providing search results relevant to the topics and concepts of a dialog can be implemented in practice. In FIG. 5, multiple participant computing devices 502, a dialog computing device 512, and a search engine 514 are communicatively coupled to one another over a network 516, such as the Internet and/or another type of network. Three participant computing devices 502 are depicted in FIG. 5, but there can be as few as two devices 502 and more than three devices 502 as well. One of the participant computing devices 502 is depicted in representative detail in FIG. 5. Each participant of the dialog uses a corresponding participant computing device 502.

The dialog computing device 512 may be a server computing device, and when present manages a dialog among the participant computing devices 502 in a client-server methodology. In another implementation, the participant computing devices 502 may manage a dialog among themselves in a peer-to-peer methodology. The search engine 514, which may be a server computing device, returns search results for modified queries. In another implementation, the search engine 514 may be part of the dialog computing device 512 or vice-versa.

Each participant computing device 502 may be a desktop or laptop computer, or another type of computing device. Each participant computing device 502 includes at least a processor 504 and a storage device 506, and may and typically does include other components as well. The storage device 506 may include volatile and non-volatile storage media. The storage device 506 of a participant computing device 502 may store just the personalized profile 508 of the participant who is using the computing device 502 in question, as in FIG. 5, or may store the personalized profile of each participant using one of the other computing devices 502 in another implementation.

The storage device 506 also stores computer-executable code 510. In the example of FIG. 5, the processor 504 executes the code 510 to determine individualized search results per the method 100 and/or collective search results per the method 200. When performing the method 200, if a particular participant computing device 502 does not store the personalized profiles of each participant of the dialog, the computing device 502 receives the personalized profiles of the other participants from their own respective participant computing devices 502. Thus, each participant computing device 502 in FIG. 5 generates one or more modified search queries, and submits the queries to the search engine 514. In return, each participant computing device 502 receives individualized and/or collective search results from the search engine 514 that are related to the dialog, and displays them to its corresponding participant.

In FIG. 6, multiple participant computing devices 602, a dialog computing device 612, and a search engine 614 are communicatively coupled to one another over a network 616, such as the Internet and/or another type of network. Each participant of the dialog uses a corresponding participant computing device 602. The dialog computing device 612 may be a server computing device, and manages a dialog among the participant computing devices 602 in a client-server methodology. The search engine 614, which may be a server computing device, returns search results for modified queries. In another implementation, the search engine 614 may be part of the dialog computing device 612 or vice-versa.

The dialog computing device 612 includes at least a processor 604 and a storage device 606, and may and typically does include other components as well. The storage device 606 may include volatile and non-volatile storage media. The storage device 606 stores the personalized profiles 608 of the participants of the dialog that are using the participant computing devices 602 to participate in the dialog. The storage device 606 further stores computer-executable code 610 that the processor 604 executes to determine individual search results for the participant of each participant computing device 602 per the method 100 and/or to collective search results per the method 200.

The dialog computing device 612 thus generates modified search queries and submits them to the search engine 614. In return, the dialog computing device 612 receives individualized search results for each participant and/or collective search results from the search engine 514 that are related to the dialog. The dialog computing device 612 sends the collective search results to each participant computing device 602, and/or sends the individualized search results pertaining to a particular participant to that participant's computing device 602.

The difference between the systems 500 and 600, therefore, is where the methods 100 and 200 are performed. In the system 500, the participant computing devices 502 each can perform the methods 100 and 200. That is, in the system 500, the participant computing devices 502 each extract dialog keywords and modify a base search query to generate one or more modified search queries for which relevant search results are returned. By comparison, in the system 600, the dialog computing device 612 performs the methods 100 and 200. That is, in the system 600, the dialog computing device 612 extracts dialog keywords to generate modified search queries for which relevant search results are returned.

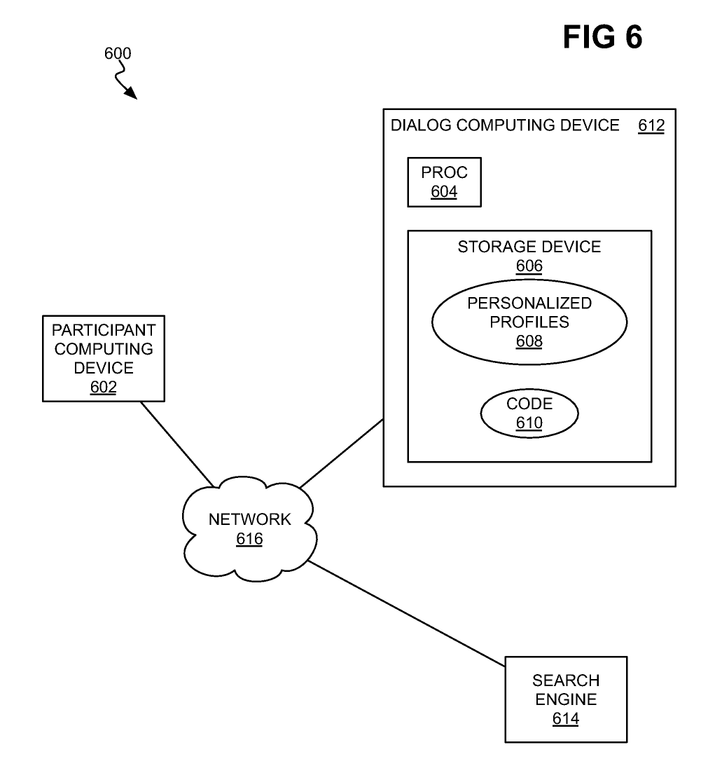

FIG. 7 shows another example method 700 that is a generalization of the method 100 that has been described above. Like the other methods that have been described, the method 700 can be implemented as code stored on a non-transitory computer-readable medium. Execution of the code by a processor causes the method 700 to be performed.

The method 700 includes extracting dialog keywords, as a search query, from a dialog of a number of participants (702). The dialog keywords represent primary concepts of the dialog. The method 700 includes modifying the search query based on the personalized profile of a selected participant (704). The personalized profile is generated from at least a contextual information source regarding the selected participant other than prior search queries made by the selected participant. The method 700 includes evaluating the modified search query against an information store to retrieve search results relevant to the modified search query (706), and outputting the search results to the selected participant (708).

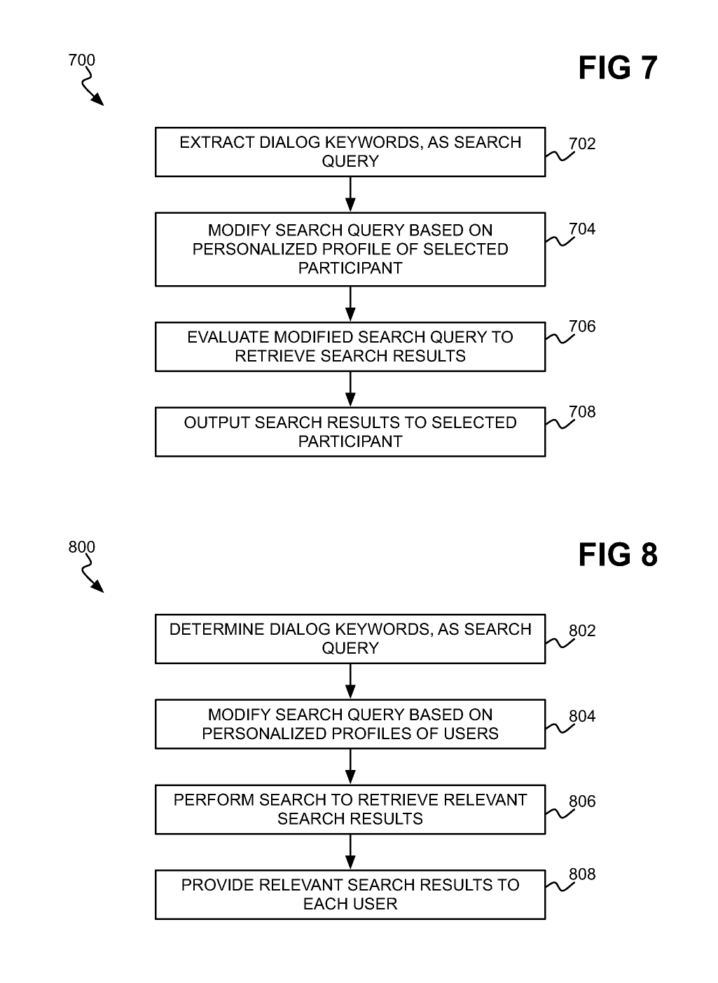

FIG. 8 shows another example method 800 that is a generalization of the method 200 that has been described above. Like the other methods that have been described, the method 800 can be implemented as code stored on a non-transitory computer-readable medium. Execution of the code by a processor causes the method 800 to be performed.

The method 800 includes determining dialog keywords, as a search query, of a dialog of a number of users (802). The method 800 includes modifying the search query based on personalized profiles of the users (804). The personalized profiles are generated from at least a contextual information source regarding the users other than prior search queries made by the users. The method 800 includes performing a search of an information store using the modified search query to retrieve relevant search results (806), and providing the relevant search results to each user (808).

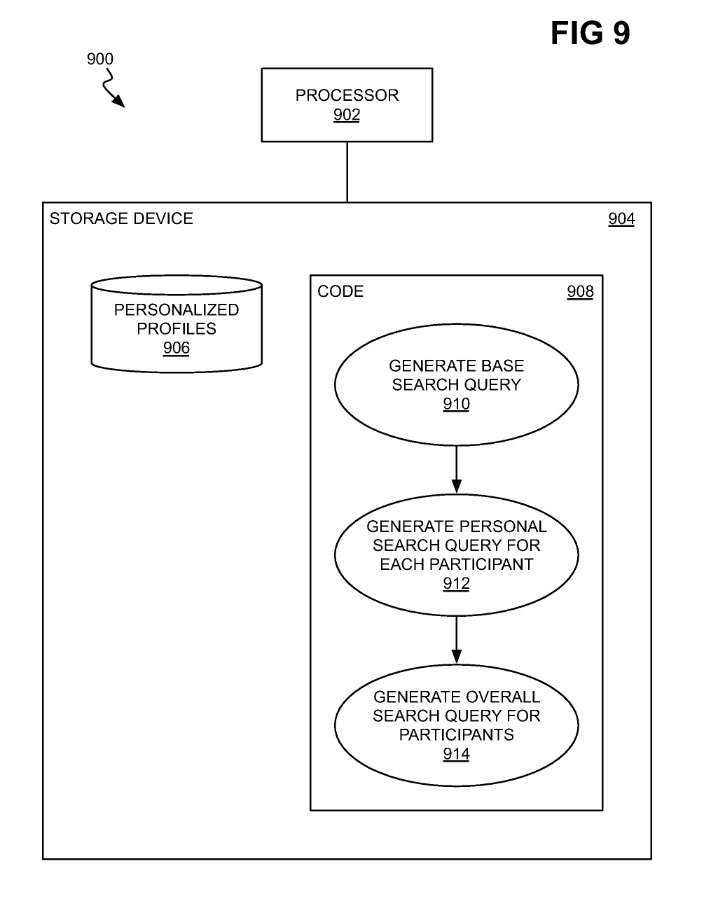

FIG. 9 shows another example system 900 that can be used to perform the methods that have been described, such as the methods 700 and 800. The system 900 includes a processor 902 and a storage device 904. The storage device 904 stores personalized profiles 906 and computer-executable code 908. The personalized profiles 906 correspond to and are for participants. Each of the personalized profiles 906 includes contextual keywords for a corresponding participant, and was generated from at least a contextual information source other than previously made searches.

The processor 902 executes the computer-executable code 908 to perform at least the following. The processor 902 executes the code 908 to generate a base search query as dialog keywords of a dialog in which the participants are contributing (910). The dialog keywords represent concepts of the dialog. The processor 902 executes the code 908 to, for each participant, generate a personal search query for the participant, as the base search query to which the contextual keywords of the personalized profile of the participant are added (912). The processor 902 executes the code 908 to generate an overall search query for the participants as a whole, as the base search query to which the contextual keywords of the personalized profile of each participant are added (914).

We claim:

1. A non-transitory computer-readable medium storing code that when executed by a processor causes the processor to:
extract dialog keywords from a dialog of a plurality of participants, as a search query, the dialog keywords representing primary concepts of the dialog;
modify the search query based on a personalized profile, of a selected participant, generated from at least a contextual information source regarding the selected participant other than prior search queries made by the selected participant;
evaluate the modified search query against an information store to retrieve search results relevant to the modified search query; and
output the search results to the selected participant.

2. The non-transitory computer-readable medium of claim 1, wherein the keywords extracted from the dialog are based on contributions of all the participants within the dialog.

3. The non-transitory computer-readable medium of claim 1, wherein the keywords extracted from the dialog are based on contributions of just the selected participant within the dialog.

4. The non-transitory computer-readable medium of claim 1, wherein the processor is to modify the search query by:
determining a current context of the selected participant based on at least one of a current time, a current day, and a current location of the selected participant;
selecting a current persona of the selected participant from a plurality of personas of the selected participant within the personalized profile of the selected participant, using the current context of the selected participant, each persona corresponding to different types of contextual information regarding the selected participant; and
modifying the search query based on just the current persona of the selected participant.

5. The non-transitory computer-readable medium of claim 1, wherein the processor is to modify the search query by:
determining a current context of the selected participant based on at least one of a current time, a current day, and a current location of the selected participant;
weight each persona of a plurality of personas of the selected participant within the personalized profile of the selected participant, based on the current context of the selected participant, each persona corresponding to different types of contextual information regarding the selected participant; and
modifying the search query based on the weighted personas of the selected participant.

6. The non-transitory computer-readable medium of claim 1, wherein the processor is to modify the search query by:
retrieving a plurality of contextual keywords from the personalized profile of the selected participant; and
appending the plurality of contextual keywords to the search query to generate the modified search query.

7. The non-transitory computer-readable medium of claim 4, wherein the processor is to modify the search query by further:
weighting the dialog keywords within the modified search query by a first coefficient; and
weighting the contextual keywords within the modified search query by a second coefficient.

8. The non-transitory computer-readable medium of claim 1, wherein the processor is to modify the search query by:
retrieving a plurality of contextual keywords from the personalized profile of the selected participant; and
appending the plurality of contextual keywords to the search query using a logical AND operator, the contextual keywords separated from one another within the search query by one or more logical OR operators.

9. The non-transitory computer-readable medium of claim 8, wherein each contextual keyword has a weight corresponding to its contextual relevant to the selected participant.

10. The non-transitory computer-readable medium of claim 1, wherein the modified search query comprises keywords based on a current context of the selected participant.

11. A method comprising:
determining, by a processor, dialog keywords of a dialog of a plurality of users, as a search query, the dialog keywords representing key concepts of the dialog;
modifying, by the processor, the search query based on personalized profiles of the users generated from at least a contextual information source regarding the users other than prior search queries made by the users;
performing, by the processor, a search of an information store using the modified search query to retrieve relevant search results; and
providing, by the processor, the relevant search results to each user.

12. The method of claim 11, wherein modifying the search query comprises:
obtaining a plurality of contextual keywords from the personalized profiles of the users; and
appending the plurality of contextual keywords for the users to the search query to generate the modified search query.

13. The method of claim 11, wherein modifying the search query comprises:
obtaining a plurality of contextual keywords from the personalized profiles of the users; and
appending the plurality of contextual keywords to the search query using a logical AND operator, the contextual keywords separated from one another within the search query by one or more logical OR operators.

14. A system comprising:
a processor; and
a storage device storing:
a plurality of personalized profiles corresponding to and for a plurality of participants, each personalized profile including a plurality of contextual keywords for a corresponding participant and generated from at least a contextual information source other than previously made searches; and
computer-executable code,
wherein the processor is to execute the computer-executable code to:
generate a base search query as dialog keywords of a dialog in which the participants are contributing, the dialog keywords representing concepts of the dialog;
for each participant, generate a personal search query for the participant as the base search query to which the contextual keywords of the personalized profile of the participant are added; and
generate an overall search query for the participants as a whole as the base search query to which the contextual keywords of the personalized profile of each participant are added.

15. The system of claim 14, wherein the processor is to execute the computer-executable code to further:
perform a search of an information store for the overall search query and report corresponding overall search results to each participant; and
for each participant, perform a search of the information search for the personal search query of the participant and reporting corresponding personal search results to the participant.
